(19) United States
(12) Patent Application Publication
(10) Pub. No.: US 2006/0291833 A1
(43) Pub. Date: Dec. 28, 2006

(54) Switchable reflector wall concept

(75) Inventor: Paul Janis Timans, Mountain View, CA (US)

Correspondence Address: DORITY & MANNING, P.A., POST OFFICE BOX 1449, GREENVILLE, SC, 29602-1449, US

(73) Assignee: Mattson Techonology, Inc.

(21) Appl. No.: 11/441,810

(22) Filed: May 26, 2006

Related U.S. Application Data
(60) Provisional application No. 60/686,341, filed on Jun. 1, 2005.

(51) Int. Cl. A21B 2/00; F26B 19/00

(52) U.S. Cl. 392/416

(57) ABSTRACT

A method and apparatus for heating substrates, such as semiconductor wafers is disclosed. In accordance with the present disclosure, a thermal processing chamber includes at least one reflector. The reflector has a reflectivity that changes in response to either temperature, intensity of electromagnetic radiation incident on the reflector, or spectrum of electromagnetic radiation incident on the reflector. In this manner, the reflectivity of the reflector can be controlled during thermal processing. In this manner, the temperature of the substrate being heated can be controlled or otherwise altered.

### RELATED APPLICATIONS

The present application is based on and claims priority to a provisional application having Ser. No. 60/686,341 filed on Jun. 1, 2005.

### BACKGROUND OF THE INVENTION

This disclosure describes an approach for achieving fast cooling in an RTP (rapid thermal processing) chamber without the need to sacrifice high heating efficiency. U.S. patent application Ser. No. 10/629,400 filed Jul. 28, 2003 suggested an approach for forming a selective reflector that reflects lamp radiation efficiently while minimizing the back reflection of thermal radiation to the wafer. U.S. patent application Ser. No. 10/706,367 filed Nov. 12, 2003 suggested that a shutter assembly could be used to cut off the lamp heating at a fixed point in the heating cycle, and simultaneously change the chamber wall from being in a reflecting condition to being in an absorbing condition. Other approaches for achieving the latter effect have been described in the prior art, including methods based on mechanical switching of the reflecting wall (E. Bussman, German patent DE 4,142,466), electrical switching of the reflecting wall by changing the hydrogen content state in a solid-state electrolyte such as ZrO₂Hₓ (F. Roozeboom, ECS Proc PV 2001-9, p. 41), or electrical switching through use of an electrochromic coating (U.S. Pat. No. 6,803,546).

### SUMMARY

In general, the present disclosure is directed to a process and apparatus for heating substrates, such as semiconductor wafers. In one embodiment, the present disclosure is directed to a method for controlling the temperature of a wafer. The method includes the steps of heating a wafer with radiant energy emitted by an energy source in a thermal processing chamber. The thermal processing chamber includes at least one reflector. In particular, in accordance with the present disclosure, the reflector has a reflectivity that changes in response to changes in temperature, to changes in the intensity of electromagnetic radiation incident on the reflector, or to changes in the spectrum of electromagnetic radiation incident on the reflector.

In accordance with the present disclosure, the reflectivity of the reflector is altered during the heating process by either changing the temperature of the reflector or the intensity or spectrum of electromagnetic radiation incident on the reflector. In this manner, the reflector can be used to further control the wafer temperature.

The reflector can be positioned at any suitable location within the thermal processing chamber. For instance, the reflector can be positioned so as to reflect radiant energy being emitted by the energy source and/or may be positioned so as to reflect radiant energy being emitted by the wafer itself.

Other features and aspects of the present invention are discussed in greater detail below.

### BRIEF DESCRIPTION OF THE DRAWING

A full and enabling disclosure of the present disclosure, including the best mode thereof, directed to one of ordinary skill in the art, is set forth more particularly in the remainder of the specification, which makes reference to the appended figure, in which:

FIG. 1 is a cross sectional view of one embodiment of a thermal processing chamber that can be used in the process of the present disclosure.

Repeat use of reference characters in the present specification and drawings is intended to represent the same or analogous features or elements of the invention.

### DETAILED DESCRIPTION

The idea presented here also involves switching the reflectivity of the chamber wall, but in this case the materials used are switched between reflecting states by altering either their temperature or the spectrum or intensity of electromagnetic radiation that they are exposed to. Such switching presents some advantages relative to the prior art. For example, the approaches do not require the use of mechanical features on the reflectors, or the use of electrical contacts on the reflectors. Such mechanical or electrical features may be delicate and could easily be damaged by the harsh irradiation conditions in an RTP chamber.

The first approach involves a reflector whose reflectivity is controlled by its temperature. The reflector could be deployed in various positions within an RTP chamber, for example it could form part of the chamber wall, where it can serve to reflect or absorb electromagnetic radiation as desired. The reflector may be heated deliberately, by an auxiliary heating system, or it may be heated at least in part by the radiation emitted by energy sources within the chamber or by the wafer or other heat source. The reflector temperature may be allowed to vary naturally during the thermal processing, or it may be controlled by a control system. The temperature of the reflector may be measured by instruments and the readings used for feedback control of the reflector temperature, or the temperature of some other part of the system, or the wafer itself.

One example of a reflector of controlled temperature is a reflector that contains a heating element. It may also contain a cooling element. Either of these elements may be controlled to determine a temperature distribution across the reflector. The thermal mass or thermal response time of the reflecting element can be optimized in order to obtain a sufficiently fast response of change in reflectivity. Another approach may have the reflector immersed within a medium whose temperature is controlled. The medium may be set at a temperature near the transition temperature for reflectivity switching, so that relatively small changes in either its temperature, or the temperature of the reflector, can produce a large change in reflectivity. Such an approach decreases the heat that needs to be delivered to or removed from the reflector, allowing more rapid and efficient switching behavior.

The reflector or the medium containing the reflector may contain temperature sensors, or indeed the system can include other sensors that sense the reflectivity of the reflector directly. The feedback from such sensors can be used to control a control system that regulates the temperature of the reflector, or its reflectivity, or even the temperature of the wafer. In some cases such sophistication is not needed and it is enough to switch the reflectivity of the reflector at a given point in a heating cycle. For example in order to initiate a fast-cooling phase of a heating cycle, the reflectivity may be switched from a higher value to a lower value at a given point in the heating cycle.

We should also note that the optical properties change need not necessarily be just a change in reflectivity. It may also involve a change in the light transmission or the light scattering properties of the element. Such a property of variable transmission can be combined with a reflecting or absorbing element behind the switched transmission element if desired.

One example of a material that can be used for a switchable reflector is an oxide of vanadium, for example VO₂. This material switches its reflectivity over a rather narrow temperature range, becoming highly reflective for infra-red radiation when it's temperature exceeds the transition point. The change in reflectivity occurs as a result of a phase transition. In pure VO₂ the transition occurs at ≈68° C. Other species of atoms can be used to dope the vanadium oxide, in order to enhance the switching properties, for example by setting a specific temperature range for the switching behavior. One useful species for such doping is tungsten. The tungsten may be incorporated at an optimized concentration, typically between 0.01 and 10% of the atomic composition. Other useful dopant species that can include Mo, Nb, Ta, Re, which, like W tend to replace V atoms in the film. It is also possible to introduce F atoms to partially replace the O atoms in the film. The degree of stress in the film can also be used to modulate its properties.

The vanadium oxide can be formed by various means, for example by a thin film coating on another substrate, such as a metal or an alloy, a ceramic, a crystal, a glass, a semiconductor or a plastic. The coating may be formed by conventional deposition means such as chemical vapor deposition (CVD), physical vapor deposition (PVD), sputtering, evaporation, plasma spraying etc. The film thickness can be optimized to provide the desired change in optical properties and the desired response time for switching. For a reflector based on a film of VO₂, the film should be at least 1 nm thick, and preferably it should be more than more than 20 nm thick. The optical properties of the film, the substrate behind it, and any overlayers applied to it, can be optimized for the desired characteristics of reflectivity, transmissivity, absorptivity or emissivity as desired. The designs can be optimized by conventional methods of optical modeling and thin film coating designs.

Although we have discussed the use of vanadium oxide as a switchable element, any material whose optical properties change significantly with temperature could be used for this application. Thermochromic materials change colour as a result of chemical reaction or phase transformations. Thermochromic behavior has been seen in both organic and inorganic compounds. Examples of thermochromic organic compounds include compounds in the anil, spiropyrans, polyvinyl acetal resin and hyroxide groups. Thermochromic inorganic materials include Agl, Ag₂Hgl₄, Cd₃P₃Cl, Hgl, Hgl₂, SrTiO₃, as well as cobalt, copper and tin complexes. Thermotropic materials undergo a physical phase transformation that results in a large change in absorption or scattering behavior. Examples include transitions between insulating and metallic states, or semiconducting and metallic states or insulating and semiconducting states. Such behavior is seen in many metal compounds such as Fe₃O₄, FeSi₂, NbO₂, NiS, Ti₂O₃, Ti₄O₇, Ti₅O₉, VO₂ and V₂O₃. These materials are sometimes referred to as Mott transition compounds. Other physical changes can also be exploited, so long as they cause a change in the optical properties or light scattering properties of the material. One example is inorganic/liquid composites that exhibit thermochromism as a result of the Christiansen effect. Other materials include polymer hydrogels. Such materials can switch between a transmitting state and a cloudy reflecting state as their temperature varies. Liquid crystals can also display temperature-dependent optical properties.

Apart for temperature changes, other methods may also be used for switching the reflectivity or transmissivity of the element. For example, a material that is photochromic could be used as the element, and its reflectivity or transmissivity could be controlled by illuminating it with light from a radiation source. The intensity of illumination from the radiation source or the spectral content of the illumination may be changed in order to affect the reflectivity or transmission of the element. The radiation may emanate form an auxiliary energy source, or from the lamps of the RTP system, or the wafer or other component within the RTP system. One group of photochromic materials is glasses containing silver halides, whose optical properties can be changed by illumination with visible and near-UV light. Other types of glasses, for example those containing hackmanite or rare earth elements may also exhibit photochromic behavior. Certain organic materials can also be photochromic as a result of heterolytic or homolytic cleavage, cis-trans isomerization and tautomerism. Example materials include spirooxazines and spiropyrans.

We should also note that the illumination can be controlled by changing the polarization properties of an element within the system. The change in polarization properties may then be used to affect the transfer of radiation from an energy source to the wafer, or the transfer of heat from the wafer to other parts of the RTP system.

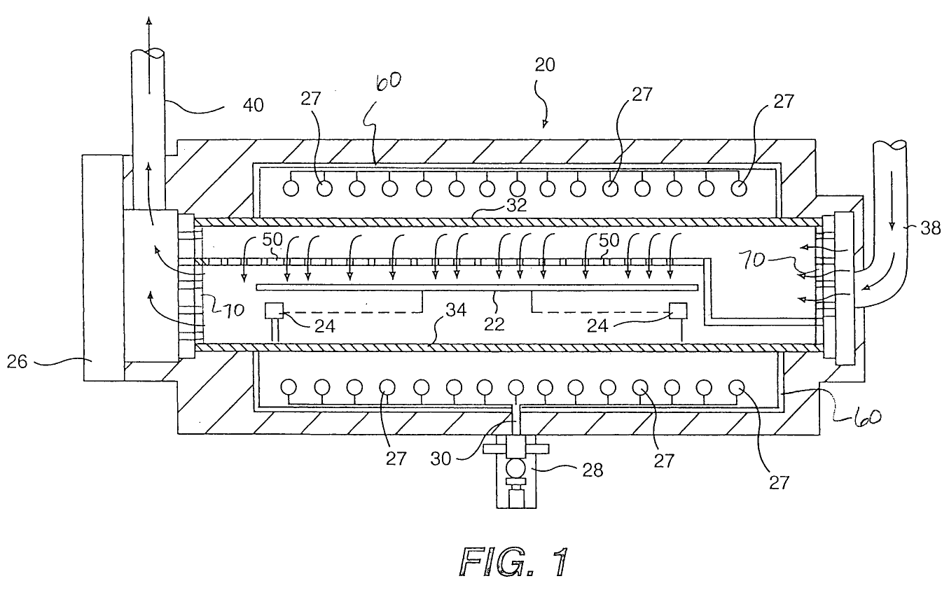

As described above, the process of the present invention is designed to be carried out in a thermal processing chamber. For instance, referring to FIG. 1, one embodiment of a thermal processing chamber (20) is shown.

Thermal processing chamber (20) is adapted to receive a semiconductor wafer (22), for conducting various processes. In particular, thermal processing chamber (20) is designed to heat wafer (22) at very rapid rates and under carefully controlled conditions. Semiconductor wafers are loaded into and out of chamber (20) through a door (26).

Thermal processing chamber (20) can be made from various materials including metals and ceramics. In one embodiment of the present invention, chamber (20) includes interior walls made from a nonconductive material, such as quartz.

As shown, wafer (22) is positioned within thermal processing chamber (20) on a substrate holder (24). During processing, substrate holder (24), in one embodiment, can be adapted to rotate wafer (22). Rotating the wafer promotes greater temperature uniformity over the surface of the wafer and promotes enhanced contact between wafer (22) and a gas being circulated through the chamber. It should be understood, however, that besides wafers, thermal processing chamber (20) is also adapted to process optical parts, films, fibers, ribbons, and other substrates having any particular shape.

In order to heat wafer (22), the system of the present invention includes a heat source in communication with thermal processing chamber (20). In the embodiment illustrated, the heat source comprises a plurality of radiant energy sources, such as lamps (27). The lamps (27), for instance, can comprise tungsten halogen lamps, arc lamps, laser diodes, lasers, plasma lamps, combinations thereof, and the like. The lamps can be positioned above and below wafer (22) as shown in the figure, or can be placed only above or only below the wafer. Besides being placed above and below wafer (22), lamps (27) may be positioned at any other location within the thermal processing chamber.

The use of lamps (27) as a heat source is generally preferred. For instance, lamps have much higher heating and cooling rates than other heating devices, such as electrical elements or conventional furnaces. Lamps (27) create a rapid thermal processing system that provides instantaneous energy, typically requiring a very short and well controlled startup period. The flow of energy from lamps (27) can also be abruptly stopped at any time. Lamps (27) can be equipped with a gradual power controller that can be used to increase or decrease the thermal energy being emitted by the lamps.

In order to monitor the temperature of wafer (22) during operation of thermal processing chamber (20), a temperature sensing device, such as a radiation sensing device (28) is included. Radiation sensing device (28), which can be, for instance, a pyrometer, includes an optical fiber or light pipe (30) which extends from radiation sensing device (28) adjacent to wafer (22).

Light pipe (30) is configured to receive thermal energy being emitted by wafer (22) at a particular wavelength. The amount of sensed radiation is then communicated to radiation sensing device (28) which generates a usable voltage signal for determining the temperature of the wafer. In particular, by knowing the amount of thermal radiation being emitted by wafer (22) at a particular wavelength, the temperature of the object can be calculated based, in part, on Planck's Law.

During the process, light pipe (30) should only detect thermal radiation being emitted by wafer (22) and should be prevented from detecting thermal radiation being emitted by lamps (27) at the desired wavelength. In this regard, thermal processing chamber (12) can include spectral filters (32) and (34) which are positioned between lamps (27) and the end of light pipe (30). Spectral filters (32) and (34) are designed to filter out thermal radiation being emitted by lamps (27) which is at the wavelength at which radiation sensing device (28) operates. For instance, in one embodiment, spectral filters (32) and (34) can be made from fused silicon or quartz.

It should be understood that besides containing a single radiation sensing device (28), thermal processing chamber (20) can include a plurality of radiation sensing devices positioned at different locations. Further, besides using pyrometers or in addition to using pyrometers, thermal processing chamber (20) can contain thermocouples which monitor the temperature of the wafer.

In one embodiment, the temperature sensing device is connected to a controller which controls the amount of light energy being emitted by lamps (27). In this manner, the amount of light energy being emitted by the lamps can be controlled directly in relation to the temperature of the wafer.

The thermal processing chamber (20) can further include a gas inlet (38) and a gas outlet (40) for circulating one or more gases into the chamber (optional). For instance, one or more gases can be introduced into thermal processing chamber (20) containing a gaseous reactant which is designed to react with semiconductor wafer (22) for depositing a film or coating on the surface of the wafer. If desired, the gas or gases entering thermal processing chamber (20) can be preheated.

Further, in one embodiment, gases entering the chamber can be uniformly dispersed over the surface of the wafer in order to promote a uniform reaction. For instance, thermal processing chamber (20) can include a dispersing device that directs and disperses the gas over the surface of the wafer where the reaction is intended to occur. For example, as shown in FIG. 1, in one embodiment, a perforated plate (50) is positioned over the top surface of semiconductor wafer (22). Perforated plate (50) includes a plurality of holes through which the gas is directed prior to contacting the wafer. By distributing the gas evenly over the wafer surface, the process produces a film having a more uniform thickness and promotes a uniform temperature distribution throughout the wafer.

It should be understood, however, that the perforated plate (50) is optional. Thus, in one embodiment, the gas or gases being fed to the chamber can simply flow over the surface of the wafer.

In accordance with the present disclosure, the thermal processing chamber (20) can include at least one reflector that is designed to reflect radiant energy being emitted by the lamps (27) or by the wafer (22). As described above, the reflector can be configured to have a reflectivity that changes in response to either temperature, the intensity of electromagnetic radiation, or the spectrum of the electromagnetic radiation that contacts the reflector. In this manner, the reflector can be used to further control the temperature of the wafer (22) during heating.

In general, the reflector can be positioned at any appropriate location within the thermal processing chamber (20). For instance, a reflector (60) may be positioned behind the lamps (27) for reflecting light onto the wafer (22). The reflector (60) can have any suitable shape. For instance, the reflector can conform to the walls of the chamber as shown in FIG. 1 or can have a curved configuration that surrounds each individual lamp.

In addition to being placed behind the lamps (27), a reflector (70) may also be positioned on the interior walls of the chamber. For instance, as shown, the reflector (70) made in accordance with the present disclosure may be positioned to surround the edges of the wafer (22).

These and other modifications and variations to the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention.

What is claimed:

1. A method for controlling the temperature of a substrate comprising:
heating a wafer with radiant energy emitted by an energy source in a thermal processing chamber, the thermal processing chamber including at least one reflector;
reflecting at least part of the radiant energy emitted by the energy source or part of the radiant energy emitted by the wafer with the reflector; and
altering the reflectivity of the reflector by changing the temperature of the reflector, the intensity of electromagnetic radiation incident on the reflector, or the spectrum of electromagnetic radiation incident on the reflector.

2. A method as defined in claim 1, wherein the reflectivity of the reflector is changed by changing the temperature, the temperature of the reflector being controlled by a heating or cooling element.

3. A method as defined in claim 1, wherein the reflector comprises an oxide of vanadium.

4. A method as defined in claim 3, wherein the oxide of vanadium is doped.

5. A method as defined in claim 4, wherein the oxide of vanadium is doped with tungsten, molybdenum, niobium, tantalum, rhenium, or mixtures thereof.

6. A method as defined in claim 1, wherein the reflector comprises a thermochromic material.

7. A method as defined in claim 1, wherein the reflector comprises a photochromic material.

8. A method as defined in claim 7, wherein the photochromic material comprises a glass containing a silver halide.
